(19) United States
(12) Patent Application Publication
(10) Pub. No.: US 2026/0175088 A1
(43) Pub. Date: Jun. 25, 2026

(54) GOLF BALL COMPOSITIONS

(71) Applicant: Acushnet Company, Fairhaven, MA (US)

(72) Inventor: Erin C. McDermott, Providence, RI (US)

(73) Assignee: Acushnet Company, Fairhaven, MA (US)

(21) Appl. No.: 18/989,290

(22) Filed: Dec. 20, 2024

(51) Int. Cl. A63B 37/00; C08K 5/37; C08L 9/00

(52) U.S. Cl. CPC A63B 37/0051; C08K 5/37; C08L 9/00; A63B 37/0061; A63B 37/0065; C08L 2312/00

(57) ABSTRACT

Compositions including zinc salts of sulfur-based accelerators, combinations of zinc salts of sulfur-based accelerators, and golf ball cores made from such compositions are disclosed. The type and concentration of components in the composition affect the properties of cores made therefrom, including, for example, coefficient of restitution and compression, and, thus, can be used to produce golf balls having desirable performance characteristics.

### FIELD OF THE INVENTION

The present disclosure relates generally to compositions for use in golf ball cores that provide for manipulation of the coefficient of restitution and compression of such cores. More particularly, the present disclosure provides compositions and golf ball cores made from such compositions that provide an ability to tailor and/or improve certain ball properties when such cores are used in a golf ball. In some respects, the present disclosure relates to golf ball cores with tailorable coefficient of restitution and compression that, when used in golf balls, provide the ability to achieve one or more desired characteristics including, for example, high durability and soft feel.

### BACKGROUND OF THE INVENTION

The primary source of resilience, as measured by coefficient of restitution (“COR”), in commercially available golf balls is polybutadiene rubber, which is typically the largest material by volume of the core. It is known that the resilience of a golf ball core, at a given compression, may be increased by including zinc pentachlorothiophenol (“ZnPCTP”) in the composition, and golf ball manufacturers have been adding ZnPCTP to rubber core formulations for many years to achieve this and other benefits.

There is an ongoing effort in many industries to establish suitable alternative compositions in order to make supply chains as efficient and economical as possible. Because of the important role ZnPCTP can play as an additive in golf ball core compositions, it would be desirable to provide novel compositions for golf ball cores that can be used to produce golf balls having desirable performance characteristics without including ZnPCTP. The present invention provides such compositions, the use thereof in golf ball core layers, and golf balls produced with such cores.

### SUMMARY OF THE INVENTION

In one embodiment, the present invention is directed to a golf ball having at least one layer formed from a composition comprising the reaction product of a base rubber; from 5 phr to 50 phr of a crosslinking coagent selected from metal salts of acrylates, diacrylates, methacrylates, and dimethacrylates; from 0.1 phr to 5.0 phr of an organic peroxide; and from 0.1 phr to 4.0 phr of a COR agent selected from zinc 2-mercaptotoluimidazole, zinc 2-mercaptobenzothiazole, zinc dimethyldithiocarbamate, and zinc dibutyldithiocarbamate. In a particular aspect of this embodiment, the composition is substantially free of zinc pentachlorothiophenol. In another particular aspect of this embodiment, the composition is substantially free of organosulfur compounds other than the COR agent.

In another embodiment, the present invention is directed to a golf ball comprising at least one core layer formed from a composition comprising the reaction product of a base rubber; from 5 phr to 50 phr of a crosslinking coagent selected from metal salts of acrylates, diacrylates, methacrylates, and dimethacrylates; from 0.1 phr to 2 phr of an organic peroxide; and from 0.3 phr to 1.2 phr of zinc 2-mercaptotoluimidazole. In particular aspect of this embodiment, the composition is substantially free of zinc pentachlorothiophenol. In another particular aspect of this embodiment, the composition is substantially free of organosulfur compounds other than 2-mercaptotoluimidazole.

In another embodiment, the present invention is directed to a golf ball comprising at least one core layer formed from a composition comprising the reaction product of a base rubber; from 5 phr to 50 phr of a crosslinking coagent selected from metal salts of acrylates, diacrylates, methacrylates, and dimethacrylates; from 0.1 phr to 2 phr of an organic peroxide; and from 0.3 phr to 1.2 phr of zinc 2-mercaptobenzothiazole. In particular aspect of this embodiment, the composition is substantially free of zinc pentachlorothiophenol. In another particular aspect of this embodiment, the composition is substantially free of organosulfur compounds other than 2-mercaptobenzothiazole.

In another embodiment, the present invention is directed to a golf ball having at least one layer formed from a composition comprising the reaction product of a base rubber; from 5 phr to 50 phr of a crosslinking coagent selected from metal salts of acrylates, diacrylates, methacrylates, and dimethacrylates; from 0.1 phr to 5.0 phr of an organic peroxide; and from 0.1 phr to 5 phr a COR agent selected from zinc 2-mercaptotoluimidazole, zinc 2-mercaptobenzothiazole, zinc dimethyldithiocarbamate, zinc dibutyldithiocarbamate, and combinations of two or more thereof. In a particular aspect of this embodiment, the composition is substantially free of organosulfur compounds other than the COR agent.

In another embodiment, the present invention is directed to a golf ball comprising a rubber core. The rubber core is formed from a composition comprising the reaction product of a base rubber; from 5 phr to 50 phr of a crosslinking coagent selected from metal salts of acrylates, diacrylates, methacrylates, and dimethacrylates; from 0.1 phr to 2.0 phr of an organic peroxide; from 0.3 phr to 1.2 phr of zinc 2-mercaptotoluimidazole; and from 0.3 phr to 1.2 phr of zinc 2-mercaptobenzothiazole.

In another embodiment, the present invention is directed to a golf ball comprising an inner core layer and an outer core layer disposed about the inner core layer. At least one of the inner core layer and the outer core layer is formed from a composition comprising the reaction product of a base rubber; from 5 phr to 50 phr of a crosslinking coagent selected from metal salts of acrylates, diacrylates, methacrylates, and dimethacrylates; from 0.1 phr to 2.0 phr of an organic peroxide; from 0.3 phr to 1.2 phr of zinc 2-mercaptotoluimidazole; and from 0.3 phr to 1.2 phr of zinc 2-mercaptobenzothiazole.

### DETAILED DESCRIPTION

The present disclosure provides golf balls having at least one layer formed from a rubber composition comprising the reaction product of: a base rubber, a crosslinking coagent, an organic peroxide initiator, and a COR agent selected from zinc 2-mercaptotoluimidazole, zinc 2-mercaptobenzothiazole, zinc dimethyldithiocarbamate, zinc dibutyldithiocarbamate, and combinations of two or more thereof.

Suitable base rubbers include natural and synthetic rubbers and combinations of two or more thereof. Examples of natural and synthetic rubbers suitable for use as the base rubber include, but are not limited to, polybutadiene, polyisoprene, ethylene propylene rubber (EPR), ethylene-propylene-diene (EPDM) rubber, grafted EPDM rubber, styrene-butadiene rubber, styrenic block copolymer rubbers (such as “SI”, “SIS”, “SB”, “SBS”, “SIBS”, and the like, where “S” is styrene, “I” is isobutylene, and “B” is butadiene), polyalkenamers such as, for example, polyoctenamer, butyl rubber, halobutyl rubber, polystyrene elastomers, polyethylene elastomers, polyurethane elastomers, polyurea elastomers, metallocene-catalyzed elastomers and plastomers, copolymers of isobutylene and p-alkylstyrene, halogenated copolymers of isobutylene and p-alkylstyrene, copolymers of butadiene with acrylonitrile, polychloroprene, alkyl acrylate rubber, chlorinated isoprene rubber, acrylonitrile chlorinated isoprene rubber, and combinations of two or more thereof.

For example, the core may be formed from a rubber formulation that includes polybutadiene as the base rubber. Polybutadiene is a homopolymer of 1,3-butadiene. The double bonds in the 1,3-butadiene monomer are attacked by catalysts to grow the polymer chain and form a polybutadiene polymer having a desired molecular weight. Any suitable catalyst may be used to synthesize the polybutadiene rubber depending upon the desired properties. In one embodiment, a transition metal complex (for example, neodymium, nickel, or cobalt) or an alkyl metal such as alkyl lithium is used as a catalyst. Other catalysts include, but are not limited to, aluminum, boron, lithium, titanium, and combinations thereof. The catalysts produce polybutadiene rubbers having different chemical structures. In a cis-bond configuration, the main internal polymer chain of the polybutadiene appears on the same side of the carbon-carbon double bond contained in the polybutadiene. In a trans-bond configuration, the main internal polymer chain is on opposite sides of the internal carbon-carbon double bond in the polybutadiene. The polybutadiene rubber can have various combinations of cis-bond and trans-bond structures. For example, the polybutadiene rubber may have a 1,4 cis-bond content of at least 40 percent. In another embodiment, the polybutadiene rubber has a 1,4 cis-bond content of greater than 80 percent. In still another embodiment, the polybutadiene rubber has a 1,4 cis-bond content of greater than 90 percent. In general, polybutadiene rubbers having a high 1,4 cis-bond content have high tensile strength and rebound.

The polybutadiene rubber may have a relatively high or low Mooney viscosity. Generally, polybutadiene rubbers of higher molecular weight and higher Mooney viscosity have better resiliency than polybutadiene rubbers of lower molecular weight and lower Mooney viscosity. However, as the Mooney viscosity increases, the milling and processing of the polybutadiene rubber generally becomes more difficult. Blends of high and low Mooney viscosity polybutadiene rubbers may be prepared as is described in U.S. Pat. Nos. 6,982,301 and 6,774,187, the entire disclosures of which are hereby incorporated herein by reference. In general, the lower limit of Mooney viscosity may be about 30 or 35 or 40 or 45 or 50 or 55 or 60 or 70 or 75 and the upper limit may be about 80 or 85 or 90 or 95 or 100 or 105 or 110 or 115 or 120 or 125 or 130. For example, the polybutadiene used in the rubber formulation may have a Mooney viscosity of about 30 to about 80 or about 40 to about 60.

Examples of commercially available polybutadiene rubbers that can be used in rubber formulations in accordance with the present disclosure, include, but are not limited to, Kibipol® PR-040-G, a high-cis Nd-catalyzed butadiene rubber, available from Chi Mei Corporation; BR 01 and BR 1220, available from BST Elastomers of Bangkok, Thailand; SE BR 1220LA and SE BR1203, available from DOW Chemical Co of Midland, Mich.; BUDENE 1207, 1207s, 1208, and 1280 available from Goodyear, Inc of Akron, Ohio; BR 01, 51 and 730, available from Japan Synthetic Rubber (JSR) of Tokyo, Japan; BUNA CB 21, CB 22, CB 23, CB 24, CB 25, CB 29 MES, CB 60, CB Nd 60, CB 55 NF, CB 70 B, CB KA 8967, and CB 1221, available from Lanxess Corp. of Pittsburgh. Pa.; BR1208, available from LG Chemical of Seoul, South Korea; UBEPOL BR130B, BR150, BR150B, BR150L, BR230, BR360L, BR710, and VCR617, available from UBE Industries, Ltd. of Tokyo, Japan; EUROPRENE NEOCIS BR 60, INTENE 60 AF and P30AF, and EUROPRENE BR HV80, available from Polimeri Europa of Rome, Italy; KBR 01, NdBr 40, NdBR-45, NdBr 60, KBR 710S, KBR 710H, and KBR 750, available from Kumho Petrochemical Co., Ltd. Of Seoul, South Korea; DIENE 55NF, 70AC, and 320 AC, available from Firestone Polymers of Akron, Ohio; and PBR-Nd Group II and Group III, available from Nizhnekamskneftekhim, Inc. of Nizhnekamsk, Tartarstan Republic.

In another embodiment, the core is formed from a rubber formulation including butyl rubber. Butyl rubber is an elastomeric copolymer of isobutylene and isoprene. Butyl rubber is an amorphous, non-polar polymer with good oxidative and thermal stability, good permanent flexibility, and high moisture and gas resistance. Generally, butyl rubber includes copolymers of about 70 percent to about 99.5 percent by weight of an isoolefin, which has about 4 to 7 carbon atoms, for example, isobutylene, and about 0.5 percent to about 30 percent by weight of a conjugated multiolefin, which has about 4 to 14 carbon atoms, for example, isoprene. The resulting copolymer contains about 85 percent to about 99.8 percent by weight of combined isoolefin and about 0.2 percent to about 15 percent of combined multiolefin. A commercially available butyl rubber suitable for use in rubber formulations in accordance with the present disclosure includes Bayer Butyl 301 manufactured by Bayer AG.

The rubber formulations may include a combination of two or more of the above-described rubbers as the base rubber. In some embodiments, the rubber formulation of the present disclosure includes a blend of different polybutadiene rubbers. In this embodiment, the rubber formulation may include a blend of a first polybutadiene rubber and a second polybutadiene rubber in a ratio of about 5:95 to about 95:5. For example, the rubber formulation may include a first polybutadiene rubber and a second polybutadiene rubber in a ratio of about 10:90 to about 90:10 or about 15:85 to about 85:15 or about 20:80 to about 80:20 or about 30:70 to about 70:30 or about 40:60 to about 60:40. In other embodiments, the rubber formulation may include a blend of more than two polybutadiene rubbers or a blend of polybutadiene rubber(s) with any of the other elastomers discussed above. In these formulations, the rubber formulation can be modified to include the first polybutadiene rubber, the second polybutadiene rubber, such that a combination of the first and second polybutadiene rubbers (in equal parts or any combination or ratio of first polybutadiene rubber to second polybutadiene rubber ranging from 99:1 to 1:99).

In other embodiments, the rubber formulation used to form the core can include a blend of polybutadiene and butyl rubber. In this embodiment, the rubber formulation may include a blend of polybutadiene and butyl rubber in a ratio of about 10:90 to about 90:10. For example, the rubber formulation may include a blend of polybutadiene and butyl rubber in a ratio of about 10:90 to about 90:10 or about 20:80 to about 80:20 or about 30:70 to about 70:30 or about 40:60 to about 60:40. In other embodiments, the rubber formulation may include polybutadiene and/or butyl rubber in a blend with any of the other elastomers discussed above.

In further embodiments, the rubber formulation used to form the core can include a blend of polybutadiene and EPDM rubber or grafted EPDM rubber as the base rubber. In still further embodiments, the rubber formulations may include a combination of polybutadiene rubber and EPDM rubber as the base rubber. In still further embodiments, the core formulations may combine EPDM rubber and two or more different types of polybutadiene rubber, such as two or more different types of high cis-1,4 polybutadiene, as the base rubber. Rubber compositions of the present invention additionally include a crosslinking coagent, an organic peroxide, a COR agent, and optional other additives and fillers, as further disclosed below. Suitable concentrations of these components are given in parts per hundred (“phr”), unless otherwise indicated. As used herein, the term “part per hundred” is defined as the number of parts by weight of a particular component present in a mixture per 100 parts of the base rubber.

Rubber compositions of the present invention include a reactive crosslinking coagent. Suitable crosslinking coagents include, but are not limited to, metal salts of unsaturated carboxylic acids having from 3 to 8 carbon atoms; unsaturated vinyl compounds and polyfunctional monomers (e.g., trimethylolpropane trimethacrylate); phenylene bismaleimide; and combinations thereof. In one embodiment, the coagent is one or more metal salts of acrylates, diacrylates, methacrylates, and dimethacrylates, wherein the metal is selected from magnesium, calcium, zinc, aluminum, lithium, and nickel. In another embodiment, the coagent includes one or more zinc salts of acrylates, diacrylates, methacrylates, and dimethacrylates. For example, the co-agent may be zinc diacrylate (ZDA). In another embodiment, the co-agent may be zinc dimethacrylate (ZDMA). An example of a commercially available zinc diacrylate includes Dymalink® 526 manufactured by Cray Valley.

The crosslinking coagent is included in the rubber composition in varying amounts depending on the desired characteristics of the golf ball core. For example, the crosslinking coagent may be used in an amount of 5 phr or 10 phr or 15 phr or 20 phr or 25 phr or 26 phr or 27 phr or 28 phr or 29 phr or 30 phr or 31 phr or 32 phr or 33 phr or 34 phr or 35 phr or 37 phr or 38 phr or 39 phr or 40 phr or 42 phr or 45 phr or 48 phr or 50 phr, or an amount within a range having a lower limit and an upper limit selected from these values. In a particular embodiment, the crosslinking coagent is included in an amount of from 26 phr to 34 phr.

Rubber compositions of the present invention include an organic peroxide free radical initiator. Suitable organic peroxides include, but are not limited to, dicumyl peroxide; n-butyl-4,4-di (t-butylperoxy) valerate; 1,1-di (t-butylperoxy) 3,3,5-trimethylcyclohexane; 2,5-dimethyl-2,5-di(t-butylperoxy) hexane; di-t-butyl peroxide; di-t-amyl peroxide; t-butyl peroxide; t-butyl cumyl peroxide; 2,5-dimethyl-2,5-di(t-butylperoxy) hexyne-3; di (2-t-butyl-peroxyisopropyl)benzene; dilauroyl peroxide; dibenzoyl peroxide; t-butyl hydroperoxide; and combinations thereof. In a particular embodiment, the organic peroxide is dicumyl peroxide, including, but not limited to Perkadox® BC, a dicumyl peroxide free radical initiator available from Nouryon. In other embodiments, the organic peroxide is dimethyl terbutyl peroxide, including, but not limited to Trigonox® 101-50D-PD, commercially available from Nouryon.

The organic peroxide is included in the rubber composition in an amount of at least 0.05 phr, or an amount of 0.1 phr or 0.5 phr or 0.7 phr or 0.8 phr or 1 phr or 1.2 phr or 1.3 phr or 1.5 phr or 1.7 phr or 1.8 phr or 2 phr or 2.2 phr or 2.3 phr or 2.5 phr or 2.7 phr or 2.8 phr or 3 phr or 5 phr or 6 phr or 10 phr, or an amount within a range having a lower limit and an upper limit selected from these values.

Rubber compositions of the present invention include a COR agent. Suitable COR agents are zinc salts of sulfur based accelerators and antioxidants, in particular, zinc 2-mercaptotoluimidazole (“ZMTI”), zinc 2-mercaptobenzothiazole (“ZMBT”), zinc dimethyldithiocarbamate (“ZDMC”), zinc diethyldithiocarbamate (“ZDEC”), zinc dibutyldithiocarbamate (“ZDBC”), and combinations of two or more thereof. In a particular embodiment, the COR agent is zinc 2-mercaptotoluimidazole. In another particular embodiment, the COR agent is zinc 2-mercaptobenzothiazole. In another particular embodiment, the COR agent is a combination of zinc 2-mercaptotoluimidazole and zinc 2-mercaptobenzothiazole. In embodiments of the present invention wherein the COR agent is a combination of two or more thereof, each COR agent component may be included in the rubber composition in the same concentration or a different concentration than the other COR agent component(s).

The total amount of COR agent included in the rubber composition is 0.1 phr or 0.3 phr or 0.8 phr or 1.0 phr or 1.1 phr or 1.2 phr or 1.3 phr or 1.5 phr or 1.6 phr or 1.8 phr or 2.0 phr or 2.1 phr or 2.2 phr or 2.4 phr or 4.0 phr or 5.0 phr, or the total amount is within a range having a lower limit and an upper limit selected from these values.

Rubber compositions of the present invention may include radical scavengers such as a halogenated organosulfur, organic disulfide, or inorganic disulfide compounds. Suitable halogenated organosulfur compounds include, but are not limited to, pentachlorothiophenol (PCTP) and salts of PCTP such as zinc pentachlorothiophenol (ZnPCTP). In another embodiment, ditolyl disulfide, diphenyl disulfide, dixylyl disulfide, 2-nitroresorcinol, or a combination of two or more thereof is optionally added to the rubber formulation. An example of a commercially available radical scavenger includes Rhenogran® Zn-PTCP-72 manufactured by Lanxess. The radical scavenger may be included in the rubber formulation in an amount of 0.1 phr or 0.3 phr or 0.4 phr or 0.5 phr or 0.8 phr or 0.9 phr or 1.0 phr, or an amount within a range having a lower limit and an upper limit selected from these values. In a particular embodiment, the rubber composition is substantially free of PCTP and metal salts of PCTP. For purposes of the present disclosure, “substantially free of PCTP and metal salts of PCTP” means that, if any PCTP or metal salt of PCTP is present in the rubber composition, then the total amount of PCTP and metal salt of PCTP in the rubber composition, if present, is less than 0.01 phr. In another particular embodiment, the rubber composition is substantially free of organosulfur compounds other than the COR agent. For purposes of the present disclosure, “substantially free of organosulfur compounds other than the COR agent” means that, if any organosulfur compounds other than the COR agent are present in the rubber composition, then the total amount of organosulfur compounds in the rubber composition, excluding the COR agent, is less than 0.01 phr.

Rubber compositions of the present invention optionally contain one or more particulate fillers selected from inorganic fillers, such as zinc oxide, titanium dioxide, tin oxide, calcium oxide, magnesium oxide, barium sulfate, zinc sulfate, calcium carbonate, zinc carbonate, barium carbonate, mica, talc, clay, silica, lead silicate, and the like; high specific gravity metal powder fillers, such as tungsten powder, molybdenum powder, and the like; regrind, i.e., core material that is ground and recycled; and nano-fillers. The amount of particulate material(s) present in rubber compositions of the present invention is typically 5 phr or 10 phr or 30 phr or 50 phr or 100 phr, or the amount is within a range having a lower limit and an upper limit selected from these values.

Rubber compositions of the present invention optionally contain one or more additives selected from processing aids, processing oils, plasticizers, coloring agents, fluorescent agents, chemical blowing and foaming agents, defoaming agents, stabilizers, softening agents, impact modifiers, density-adjusting fillers, and the like.

In accordance with the present disclosure, the base rubber, crosslinking coagent, organic peroxide initiator, COR agent, and any optional additional materials used in forming the core composition may be combined to form a mixture by any type of mixing know to one of ordinary skill in the art, and the rubber composition may be cured using conventional curing processes.

Golf balls of the present invention include one-piece, two-piece, and multi-layer golf balls, where at least one layer is formed from a rubber composition of the present invention. In golf balls having two or more layers which comprise a rubber composition of the present invention, the rubber composition of one layer may be the same as or different than that of another layer. The layer(s) formed from the rubber composition of the present invention can be any one or more of a core layer, a cover layer, or an intermediate layer disposed between a core and a cover. Preferably, the layer(s) formed from the rubber composition of the present invention includes one or more core layer(s). In a particular embodiment, the present invention provides a golf ball having a single layer core formed from a rubber composition of the present invention. In another particular embodiment, the present invention provides a golf ball comprising a dual core having an inner core layer and an outer core layer, wherein the inner core layer is formed from a rubber composition of the present invention. In another particular embodiment, the present invention provides a golf ball comprising a dual core having an inner core layer and an outer core layer, wherein the outer core layer is formed from a rubber composition of the present invention. In another particular embodiment, the present invention provides a golf ball comprising a dual core having an inner core layer and an outer core layer, wherein the inner core layer is formed from a first rubber composition of the present invention and the outer core layer is formed from a second rubber composition of the present invention. In another particular embodiment, the present invention provides a golf ball comprising a multilayer core having an inner core layer, an outer core layer, and at least one intermediate core layer, wherein the inner core layer is formed from a rubber composition of the present invention. In another particular embodiment, the present invention provides a golf ball comprising a multilayer core having an inner core layer, an outer core layer, and at least one intermediate core layer, wherein the outer core layer is formed from a rubber composition of the present invention. In another particular embodiment, the present invention provides a golf ball comprising a multilayer core having an inner core layer, an outer core layer, and at least one intermediate core layer, wherein an intermediate core layer is formed from a rubber composition of the present invention.

The diameter and thickness of the different golf ball layers, along with properties such as hardness, compression, and COR, vary depending on the construction and desired playing performance properties of the golf ball.

Golf ball cores of the present invention include single, dual, and multilayer cores, and generally have an overall diameter of 0.75 inches or 1.00 inch or 1.20 inches or 1.25 inches or 1.40 inches or 1.45 inches or 1.50 inches or 1.51 inches or 1.53 inches or 1.55 inches or 1.58 inches or 1.60 inches or 1.61 inches or 1.62 inches or 1.63 inches, or an overall diameter within a range having a lower limit and an upper limit selected from these values. Dual and multilayer cores have an inner core layer and an outer core layer, and multilayer cores additionally have at least one intermediate core layer disposed between the inner core layer and the outer core layer. Inner core layers of the present invention generally have a diameter of 0.50 inches or 0.75 inches or 1.00 inch or 1.10 inches or 1.13 inches or 1.15 inches or 1.20 inches or 1.25 inches or 1.40 inches or 1.50 inches, or a diameter within a range having a lower limit and an upper limit selected from these values. Outer core layers of the present invention generally have a thickness of 0.08 inches or 0.10 inches or 0.15 inches or 0.20 inches or 0.21 inches or 0.22 inches or 0.25 inches or 0.28 inches or 0.31 inches or 0.44 inches or 0.50 inches, or a thickness within a range having a lower limit and an upper limit selected from these values.

Golf ball cores of the present invention generally have a compression of 50 or 60 or 65 or 70 or 75 or 80 or 85 or 90 or 95 or 100 or 100 or 110, or a compression within a range having a lower limit and an upper limit selected from these values.

Golf ball cores of the present invention generally have a coefficient of restitution (“COR”) at 125 ft/s of at least 0.750, or at least 0.775, or at least 0.780, or at least 0.782, or at least 0.785, or at least 0.787, or at least 0.790, or at least 0.795, or at least 0.800.

In a particular embodiment, the present invention provides a golf ball core having a compression of from 80 to 90 and a COR at 125 ft/s of greater than 0.800. In another particular embodiment, the present invention provides a golf ball core having a compression of 91 to 101 and a COR at 125 ft/s of greater than 0.810.

Golf ball cores of the present invention generally have a center Shore C hardness of 40 45 or 50 or 55 or 60 or 65 or 70 or 75 or 80 or 85 or 90 or a center Shore C hardness within a range having an upper limit and a lower limit selected from these values; and an outer surface Shore C hardness of 60 or 65 or 70 or 75 or 80 or 85 or 90 or 95 or an outer surface Shore C hardness within a range having an upper limit and a lower limit selected from these values. In a particular embodiment, golf ball cores of the present invention have an overall positive hardness gradient wherein the outer surface Shore C hardness is greater than the center Shore C hardness. In a particular aspect of this embodiment, the difference between the outer surface Shore C hardness and the center Shore C hardness is 5 or 10 or 15 or 19 or 20 or 21 or 22 or 23 or 24 or 25 or 28 or 30, or the difference is within a range having a lower limit and an upper limit selected from these values.

Golf balls of the present invention may include one or more layers in addition to the layer formed from a rubber composition of the present invention.

Suitable core materials for the golf balls disclosed herein include, but are not limited to, natural and synthetic rubbers, such as polybutadiene, polyisoprene, ethylene propylene rubber, ethylene propylene diene rubber, styrene-butadiene rubber, styrenic block copolymer rubbers (such as SI, SIS, SB, SBS, SIBS, and the like, where “S” is styrene, “I” is isobutylene, and “B” is butadiene), butyl rubber, halobutyl rubber, copolymers of isobutylene and para-alkylstyrene, halogenated copolymers of isobutylene and para-alkylstyrene, copolymers of butadiene with acrylonitrile, polychloroprene, alkyl acrylate rubber, chlorinated isoprene rubber, and acrylonitrile chlorinated isoprene rubber; metallocene polymers; acid copolymers and ionomers; and combinations thereof.

Suitable cover materials for the golf balls disclosed herein include, but are not limited to, polyurethanes; polyureas; copolymers, blends and hybrids of polyurethane and polyurea; ionomers of O/X- and O/X/Y-type acid copolymers, wherein O is an α-olefin, preferably ethylene or propylene, X is a C₃-C₈ α, β-ethylenically unsaturated carboxylic acid, and Y is a softening monomer (including partially neutralized ionomers and highly neutralized ionomers), and blends thereof; polyethylene, including, for example, low density polyethylene, linear low density polyethylene, and high density polyethylene; polypropylene; rubber-toughened olefin polymers; acid copolymers, for example, poly(meth)acrylic acid, which do not become part of an ionomeric copolymer; plastomers; flexomers; styrene/butadiene/styrene block copolymers; styrene/ethylene-butylene/styrene block copolymers; dynamically vulcanized elastomers; copolymers of ethylene and vinyl acetates; copolymers of ethylene and methyl acrylates; polyvinyl chloride resins; polyamides, poly (amide-ester) elastomers, and graft copolymers of ionomer; cross-linked trans-polyisoprene and blends thereof; polyester-based thermoplastic elastomers; polyurethane-based thermoplastic elastomers; synthetic or natural vulcanized rubber; and combinations thereof.

Golf balls of the present invention generally have an overall diameter within the range having a lower limit of 1.66 inches and an upper limit of 1.69 inches.

Golf balls of the present invention generally have a compression of 65 or 70 or 80 to 100 or 110 or 115, or a compression within a range having a lower limit and an upper limit selected from these values.

Golf balls of the present invention generally have a COR at 125 ft/s of at least 0.800, or at least 0.803, or at least 0.805, or at least 0.807, or at least 0.809.

The present invention is not limited by any particular process for forming the golf ball layer(s). It should be understood that the layer(s) can be formed by any suitable technique, including injection molding, compression molding, casting, and reaction injection molding.

### Test Methods

For purposes of the present disclosure, compression is measured using a Dynamic Compression Machine (“DCM”) as follows. The DCM applies a load to a golf ball or golf ball subassembly and measures the number of inches the core or ball is deflected at measured loads. A crude load/deflection curve is generated that is fit to the Atti compression scale that results in a number being generated that represents an Atti compression. The DCM does this via a load cell attached to the bottom of a hydraulic cylinder that is triggered pneumatically at a fixed rate (typically about 1.0 ft/s) towards a stationary core. Attached to the cylinder is an LVDT that measures the distance the cylinder travels during the testing timeframe. A software-based logarithmic algorithm ensures that measurements are not taken until at least five successive increases in load are detected during the initial phase of the test.

For purposes of the present disclosure, COR is determined according to a known procedure wherein a golf ball or golf ball subassembly (e.g., a golf ball core) is fired from an air cannon at a given velocity (125 ft/s for purposes of the present invention). Ballistic light screens are located between the air cannon and the steel plate to measure ball velocity. As the ball travels toward the steel plate, it activates each light screen, and the time at each light screen is measured. This provides an incoming transit time period proportional to the ball's incoming velocity. The ball impacts the steel plate and rebounds though the light screens, which again measure the time period required to transit between the light screens. This provides an outgoing transit time period proportional to the ball's outgoing velocity. COR is then calculated as the ratio of the outgoing transit time period to the incoming transit time period, COR=Tₒᵤₜ/Tᵢₙ.

For purposes of the present disclosure, “center hardness” refers to the hardness of the geometric center of the core, and “outer surface hardness” of the core refers to the hardness of the outer surface of the outermost layer of the core. Center hardness and outer surface hardness are determined as follows. The core is first gently pressed into a hemispherical holder having an internal diameter approximately slightly smaller than the diameter of the core, such that the core is held in place in the hemispherical portion of the holder while concurrently leaving the geometric central plane of the center exposed. The core is secured in the holder by friction, such that it will not move during the cutting and grinding steps, but the friction is not so excessive that distortion of the natural shape of the core would result. The core is secured such that the parting line of the center is roughly parallel to the top of the holder. The diameter of the center is measured 90 degrees to this orientation prior to securing. A measurement is also made from the bottom of the holder to the top of the core to provide a reference point for future calculations. A rough cut is made slightly above the exposed geometric center of the core using a band saw or other appropriate cutting tool, making sure that the core does not move in the holder during this step. The remainder of the core, still in the holder, is secured to the base plate of a surface grinding machine. The exposed ‘rough’ surface is ground to a smooth, flat surface, revealing the geometric center of the core, which can be verified by measuring the height from the bottom of the holder to the exposed surface of the core, making sure that exactly half of the original height of the core, as measured above, has been removed to within 0.004 inches. Leaving the core in the holder, the geometric center of the core is confirmed with a center square and carefully marked, and the hardness is measured at the center mark according to ASTM D-2240.

Additional hardness measurements at any distance from the geometric center of the core can then be made by drawing a line radially outward from the geometric center mark and measuring the hardness at any given distance along the line, typically in 2 mm increments from the center of the core. The hardness at a particular distance from the geometric center should be measured along at least two, preferably four, radial arms located 180° apart, or 90° apart, respectively, and then averaged. All hardness measurements performed on a plane passing through the geometric center are performed while the core is still in the holder and without having disturbed its orientation, such that the test surface is constantly parallel to the bottom of the holder, and thus also parallel to the properly aligned foot of the durometer.

The outer surface hardness of the core (or any golf ball layer) is measured on the actual outer surface of the layer and is obtained from the average of a number of measurements taken from opposing hemispheres, taking care to avoid making measurements on the parting line of the core or on surface defects, such as holes or protrusions and preferably making the measurements prior to surrounding the layer of interest with an additional layer. Hardness measurements are made pursuant to ASTM D-2240 “Indentation Hardness of Rubber and Plastic by Means of a Durometer.” Because of the curved surface, care must be taken to ensure that the golf ball or golf ball sub-assembly is centered under the durometer indenter before a surface hardness reading is obtained. A calibrated, digital durometer, capable of reading to 0.1 hardness units is used for the hardness measurements. The digital durometer must be attached to, and its foot made parallel to, the base of an automatic stand. The weight on the durometer and attack rate conforms to ASTM D-2240. It is worthwhile to note that, once an additional layer surrounds a layer of interest, the hardness of the layer of interest can be difficult to determine. Therefore, for purposes of the present disclosure, when the hardness of a layer is needed after the inner layer has been surrounded with another layer, the test procedure for measuring a point located 1 mm from an interface is used.

It should also be noted that there is a fundamental difference between “material hardness” and “hardness as measured directly on a golf ball” (or, as used herein, “surface hardness”). For purposes of the present disclosure, material hardness is measured according to ASTM D-2240 and generally involves measuring the hardness of a flat “slab” or “button” formed of the material. Surface hardness as measured directly on a golf ball (or other spherical surface) typically results in a different hardness value. The difference in “surface hardness” and “material hardness” values is due to several factors including, but not limited to, ball construction (that is, core type, number of layers, and the like); ball (or ball sub-assembly) diameter; and the material composition of adjacent layers. It also should be understood that the two measurement techniques are not linearly related and, therefore, one hardness value cannot easily be correlated to the other.

### EXAMPLES

It should be understood that the examples below are for illustrative purposes only. In no manner is the present invention limited to the specific disclosures therein.

The following non-limiting examples describe compositions of golf ball cores having a single layer in accordance with the present disclosure. One of ordinary skill in the art would understand that the formulations could be used or adapted for use in other golf ball layers, such as an outer core layer.

In examples 1-12, rubber compositions of the present invention were prepared by mixing polybutadiene rubber, zinc diacrylate, peroxide, zinc oxide, and ZMTI and/or ZMBT COR agent, in a Brabender mixer for 5-10 minutes. Comparative compositions C1-C3 were similarly prepared, except that no COR agent was added. The relative amount of each component used, given in parts by weight, is indicated in Tables 1 and 2 below.

The rubber compositions of Examples 1-12 and C1-C3 were then cured in a compression molding press at 350° C. for 11 minutes to obtain spheres, which were subsequently ground to a diameter of 1.55 inches (Examples 1-8 and comparative examples C1-C2) or a diameter of 1.53 inches (Examples 9-12 and comparative example C3). Each of the resulting spheres was evaluated for compression and COR at 125 ft/see, and the results are reported in Tables 1 and 2 below. Each of the resulting spheres of Examples 1-8 and C1-C2 were also evaluated for Shore C hardness gradient (i.e., outer surface Shore C hardness minus center Shore C hardness), and the results are reported in Table 1.

TABLE 1

| Composition | C1 | 1 | 2 | 3 | 4 | C2 | 5 | 6 | 7 | 8 |
|---|---|---|---|---|---|---|---|---|---|---|
| Rubber* | 100 | 100 | 100 | 100 | 100 | 100 | 100 | 100 | 100 | 100 |
| ZDA | 28 | 28 | 28 | 28 | 28 | 32 | 32 | 32 | 32 | 32 |
| Peroxide** | 0.5 | 0.5 | 0.5 | 0.5 | 0.5 | 0.5 | 0.5 | 0.5 | 0.5 | 0.5 |
| ZnO | 5 | 5 | 5 | 5 | 5 | 5 | 5 | 5 | 5 | 5 |
| ZMTI | 0 | 0.5 | 1.0 | 0.5 | 1.0 | 0 | 0.5 | 1.0 | 0.5 | 1.0 |
| ZMBT | 0 | 0.5 | 1.0 | 1.0 | 0.5 | 0 | 0.5 | 1.0 | 1.0 | 0.5 |

Properties

| | | | | | | | | | | |
|---|---|---|---|---|---|---|---|---|---|---|
| Compression | 74 | 83 | 82 | 82 | 86 | 90 | 95 | 101 | 100 | 98 |
| COR at 125 | 0.800 | 0.805 | 0.803 | 0.804 | 0.806 | 0.810 | 0.812 | 0.815 | 0.815 | 0.814 |
| ft/sec | | | | | | | | | | |
| Hardness | 21 | 21 | 22 | 21 | 22 | 23 | 21 | 21 | 21 | 22 |
| gradient | | | | | | | | | | |
| (Shore C) | | | | | | | | | | |

*Kibipol ® PR-040-G, a high-cis Nd-catalyzed butadiene rubber, commercially available from Chi Mei Corporation.
**Perkadox ® BC, a dicumyl peroxide free radical initiator commercially available from Nouryon.

TABLE 2

| Composition | C3 | 9 | 10 | 11 | 12 |
|---|---|---|---|---|---|
| Rubber* | 100 | 100 | 100 | 100 | 100 |
| ZDA | 32 | 32 | 32 | 32 | 32 |
| Peroxide** | 0.5 | 0.5 | 0.5 | 0.5 | 0.5 |
| ZnO | 5 | 5 | 5 | 5 | 5 |
| ZMTI | 0 | 0.5 | 1.0 | 0 | 0 |
| ZMBT | 0 | 0 | 0 | 0.5 | 1.0 |
| Compression | 96 | 92 | 98 | 97 | 100 |
| COR at 125 | 0.812 | 0.813 | 0.814 | 0.816 | 0.814 |
| ft/sec | | | | | |

*Kibipol ® PR-040-G, a high-cis Nd-catalyzed butadiene rubber, commercially available from Chi Mei Corporation.
**Perkadox ® BC, a dicumyl peroxide free radical initiator commercially available from Nouryon.

While the illustrative embodiments of the invention have been described with particularity, it will be understood that various other modifications will be apparent to and can be readily made by those of ordinary skill in the art without departing from the spirit and scope of the invention. Accordingly, it is not intended that the scope of the claims appended hereto be limited to the examples and descriptions set forth herein, but rather that the claims be construed as encompassing all of the features of patentable novelty which reside in the present invention, including all features which would be treated as equivalents thereof by those of ordinary skill in the art to which the invention pertains.

What is claimed is:

1. A golf ball having at least one layer formed from a composition comprising the reaction product of:
a base rubber;
from 5 phr to 50 phr of a crosslinking coagent selected from metal salts of acrylates, diacrylates, methacrylates, and dimethacrylates;
from 0.1 phr to 5.0 phr of an organic peroxide; and
from 0.1 phr to 4.0 phr of a COR agent selected from zinc 2-mercaptotoluimidazole, zinc 2-mercaptobenzothiazole, zinc dimethyldithiocarbamate, zinc diethyldithiocarbamate, and zinc dibutyldithiocarbamate;
wherein the composition is substantially free of zinc pentachlorothiophenol.

2. The golf ball of claim 1, wherein the COR agent is zinc 2-mercaptotoluimidazole and is included in an amount of from 0.3 phr to 1.2 phr.

3. The golf ball of claim 2, wherein the composition is substantially free of organosulfur compounds other than zinc 2-mercaptotoluimidazole.

4. The golf ball of claim 1, wherein the COR agent is zinc 2-mercaptobenzothiazole and is included in an amount of from 0.3 phr to 1.2 phr.

5. The golf ball of claim 4, wherein the composition is substantially free of organosulfur compounds other than zinc 2-mercaptobenzothiazole.

6. The golf ball of claim 1, wherein the composition includes from 26 phr to 34 phr of the crosslinking coagent.

7. A golf ball comprising a core layer from a composition comprising the reaction product of:
a base rubber;
from 5 phr to 50 phr of a crosslinking coagent selected from metal salts of acrylates, diacrylates, methacrylates, and dimethacrylates;
from 0.1 phr to 2 phr of an organic peroxide; and
from 0.3 phr to 1.2 phr of zinc 2-mercaptotoluimidazole;
wherein the composition is substantially free of zinc pentachlorothiophenol.

8. The golf ball of claim 7, wherein the composition is substantially free of organosulfur compounds other than zinc 2-mercaptotoluimidazole.

9. The golf ball of claim 8, wherein the composition includes from 26 phr to 34 phr of the crosslinking coagent.

10. A golf ball comprising a core layer from a composition comprising the reaction product of:
a base rubber;
from 5 phr to 50 phr of a crosslinking coagent selected from metal salts of acrylates, diacrylates, methacrylates, and dimethacrylates;
from 0.1 phr to 2 phr of an organic peroxide; and
from 0.3 phr to 1.2 phr of zinc 2-mercaptobenzothiazole;
wherein the composition is substantially free of zinc pentachlorothiophenol.

11. The golf ball of claim 10, wherein the composition is substantially free of organosulfur compounds other than zinc 2-mercaptobenzothiazole.

12. The golf ball of claim 11, wherein the composition includes from 26 phr to 34 phr of the coagent.
